(19) United States
(12) Patent Application Publication
(10) Pub. No.: US 2025/0054069 A1
(43) Pub. Date: Feb. 13, 2025

(54) EXECUTION OF LIFE INSURANCE POLICY VIA SMART CONTRACT ON BLOCKCHAIN

(71) Applicant: State Farm Mutual Automobile Insurance Company, Bloomington, IL (US)

(72) Inventors: Jacob Braun, Oviedo, FL (US); Justin Johnsen, Heyworth, IL (US)

(21) Appl. No.: 18/746,613

(22) Filed: Jun. 18, 2024

Related U.S. Application Data
(60) Provisional application No. 63/518,830, filed on Aug. 10, 2023.

(51) Int. Cl. G06Q 40/08; G06Q 20/36

(52) U.S. Cl. CPC G06Q 40/08; G06Q 20/36; G06Q 2220/00

(57) ABSTRACT

A smart contract on a blockchain represents a life insurance policy for a policyholder. The smart contract can automatically execute on the blockchain based on a notice, from a death record repository, indicating that the policyholder has died. Automatic execution of the smart contract causes an automatic transfer of funds from a transfer source identified in the smart contract to a transfer destination identified in the smart contract.

### RELATED APPLICATIONS

This U.S. patent application claims priority to provisional U.S. Patent Application No. 63/518,830, entitled “EXECUTION OF LIFE INSURANCE POLICY VIA SMART CONTRACT ON BLOCKCHAIN,” filed on Aug. 10, 2023, the entirety of which is incorporated herein by reference.

### TECHNICAL FIELD

The present disclosure relates to life insurance, and more particularly to smart contracts for life insurance policies that are configured to automatically execute on a blockchain in response to death notifications.

### BACKGROUND

Life insurance policies allow policyholders to ensure that beneficiaries, such as family members and other loved ones, have financial support when the policyholders pass away. However, in many situations, insurance claims associated with life insurance policies are submitted to insurance companies a relatively long time after policyholders have passed away, thereby delaying corresponding payments to beneficiaries.

For example, when a life insurance policyholder passes away, a beneficiary may not know that the policyholder had a life insurance policy with an insurance company. Accordingly, it may be weeks, months, or another period of time before the beneficiary discovers that the life insurance policy exists, and for the beneficiary to submit a life insurance claim to the insurance company. As another example, even if a person does know that he or she is a beneficiary of a life insurance policy held by a deceased policyholder, the person may delay submitting a life insurance claim to the insurance company because the person is grieving, handling other matters to settle the deceased policyholder's affairs, and/or for other reasons.

Additionally, when life insurance claims are submitted to an insurance company, claim handlers, other personnel, and/or automated systems associated with the insurance company may be tasked to review and process the life insurance claims. Such review and processing of life insurance claims by the insurance company may take time and utilize computing resources. As an example, data associated with a life insurance claim may be routed through different networks and systems associated with the insurance company, and thereby consume bandwidth and digital memory resources. As another example, data associated with a life insurance claim may be manually and/or automatically processed, and thereby utilize memory, processing cycles, and other computing resources of computing systems used by claim handlers and/or computer-based automatic claim processing systems.

Moreover, when life insurance claims are approved by an insurance company, settlement processes to transfer corresponding payments to beneficiaries may also take time and utilize computing resources. For example, computing resources of one or more banks or other financial institutions, as well as associated payment networks, may be used to initiate and process a payment. However, such payments may take a day or more to complete in many situations, further delaying final resolutions of life insurance claims submitted by beneficiaries.

The example systems and methods described herein may be directed toward mitigating or overcoming one or more of the deficiencies described above.

### SUMMARY

Described herein are systems and methods associated with a smart contract on a blockchain that represents a life insurance policy for a policyholder. The smart contract can include computer-executable instructions that are configured to automatically execute on the blockchain based on a notice, from a death record repository, indicating that the policyholder has died. Automatic execution of the smart contract causes an automatic transfer of funds from a transfer source identified in the smart contract to a transfer destination identified in the smart contract.

According to a first aspect, a computer-implemented method includes receiving, by one or more processors, user input indicating a first identifier of an individual associated with a policy. The computer-implemented method also includes identifying, by the one or more processors, a second identifier of a transfer source associated with the policy, and a third identifier of a transfer destination associated with the policy. The computer-implemented method further includes generating, by the one or more processors, a computer-executable policy instructions associated with the policy. The computer-executable policy instructions are configured to automatically execute, in a blockchain, and in response to a notice from a death record repository that indicates the first identifier of the individual, a transfer from the transfer source indicated by the second identifier to the transfer destination indicated by the third identifier. The computer-implemented method also includes adding, by the one or more processors, a block associated with the computer-executable policy instructions to the blockchain.

According to a second aspect, a computer-implemented method includes including determining, by one or more processors, and based on a death record repository, a notice indicating an identifier of an individual. The computer-implemented method also includes determining, by the one or more processors, that the identifier indicated by the notice corresponds with execution conditions defined in computer-executable policy instructions, stored in a blockchain, associated with a policy. The computer-implemented method additionally includes initiating, by the one or more processors, in response to the notice, automatic execution of the computer-executable policy instructions in the blockchain by automatically implementing a transfer from a transfer source identified in the computer-executable policy instructions to a transfer destination identified in the computer-executable policy instructions.

According to a third aspect, a computing system includes one or more processors and memory storing computer-executable instructions. The computer-executable instructions, when executed by the one or more processors, cause the one or more processors to receive user input indicating a first identifier of an individual associated with a policy. The computer-executable instructions also cause the one or more processors to identify a second identifier of a transfer source associated with the policy. The computer-executable instructions additionally cause the one or more processors to identify a third identifier of a transfer destination associated with the policy. The computer-executable instructions further cause the one or more processors to generate computer-executable policy instructions associated with the policy. The computer-executable policy instructions are configured to automatically execute, in a blockchain, and in response to a notice from a death record repository that indicates the first identifier of the individual, a transfer from the transfer source indicated by the second identifier to the transfer destination indicated by the third identifier. The computer-executable instructions also cause the one or more processors to add a block associated with the computer-executable policy instructions to the blockchain.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a life insurance system in which a life insurance policy held by a policyholder can be administered via a smart contract on a blockchain.

FIG. 2 shows a flowchart illustrating an example method for generating a smart contract for a life insurance policy on the blockchain.

FIG. 3 shows a flowchart illustrating an example method for automatically executing a smart contract for a life insurance policy on the blockchain, based on a corresponding death notice.

FIG. 4 shows an example system architecture for a computing system that can execute one or more elements associated with smart contracts for life insurance on the blockchain.

### DETAILED DESCRIPTION

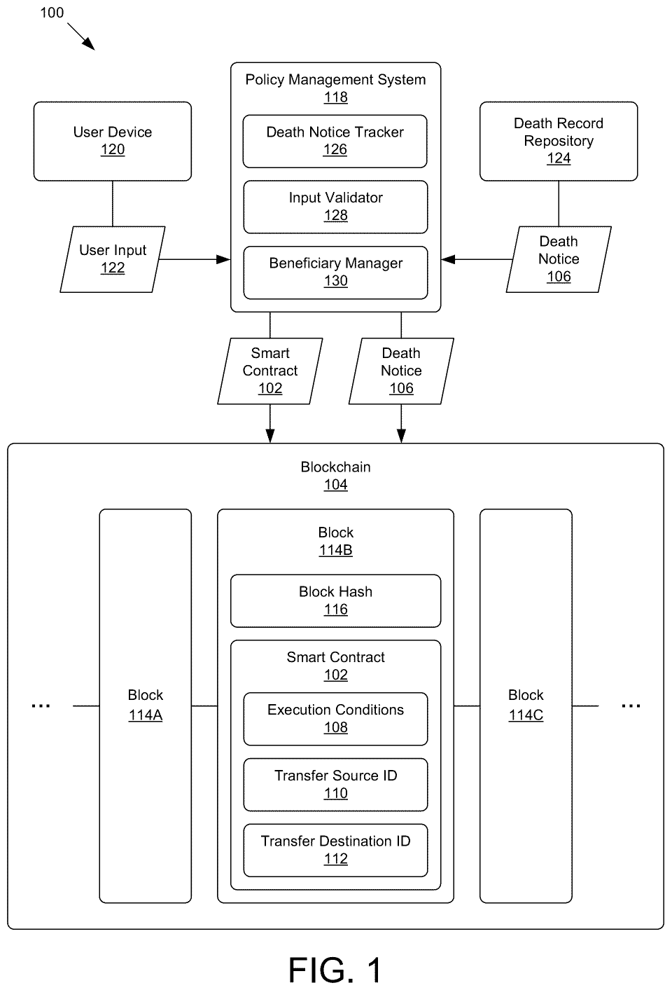

FIG. 1 shows an example of a life insurance system 100 in which a life insurance policy held by a policyholder can be administered via a smart contract 102 on a blockchain 104. The life insurance policy can provide for a payment of an amount of funds upon the death of the policyholder. For example, the life insurance policy can be a parametric life insurance policy that is associated with a payment of predetermined amount upon the policyholder's death. The smart contract 102 on the blockchain 104 can be configured to automatically execute and transfer a corresponding payment from a transfer source to a transfer destination when a death notice 106, indicating that the policyholder has died, is received or is identified. For example, the transfer source and the transfer destination may be cryptocurrency wallets.

Due to the automatic execution of the smart contract 102 upon the death of the policyholder, a payment associated with the life insurance policy can automatically be made without a beneficiary submitting an insurance claim to an insurance company or the insurance company having to process such an insurance claim. The payment can be automatically transferred to the transfer destination designated in the smart contract 102, instead of being issued to a particular named beneficiary. Accordingly, any person or entity who has access to the transfer destination, such as a cryptocurrency wallet, can access funds that are automatically transferred to the transfer destination upon the policyholder's death. The life insurance system 100 can accordingly be a fully automated end-to-end system that automatically creates the smart contract 102 based on provided data, automatically adds the smart contract 102 to the blockchain 104, and automatically executes the smart contract 102 in the blockchain 104 upon the death of the policyholder.

The smart contract 102 can be associated with programming code or other computer-executable instructions that can be executed via the blockchain 104, and that cause the smart contract 102 to automatically execute upon the occurrence of execution conditions 108 defined by the smart contract 102. For example, the execution conditions 108 can indicate that a transfer of funds will automatically occur in association with the life insurance policy upon receipt or identification of a death notice 106 indicating that the policyholder has died.

The smart contract 102 can also define a transfer source identifier 110 and a transfer destination identifier 112. The transfer source identifier 110 can identify a transfer source that is to be used as the source of the payment made upon the death of the policyholder. The transfer destination identifier 112 can similarly identify a transfer destination, to which the payment from the transfer source is to be transferred upon the death of the policyholder. Accordingly, instead of identifying a particular named beneficiary for the life insurance policy, the smart contract 102 can identify the transfer destination identifier 112 of the transfer destination to which funds will be transferred in response to the policyholder's death, such that any party who has access to the transfer destination can access the transferred funds.

The transfer destination and/or the transfer destination can, in some examples, be cryptocurrency wallets that are also stored on the blockchain 104 or a different blockchain. For example, the transfer source identifier 110 can be an identifier of a first cryptocurrency wallet that is to serve as a funding wallet associated with the smart contract 102, while the transfer destination identifier 112 can be an identifier of a second cryptocurrency wallet that is to serve as a destination wallet associated with the smart contract 102. Accordingly, when the smart contract 102 executes in response to a death notice 106 in this example, cryptocurrency funds from the funding wallet identified by the transfer source identifier 110 can be automatically transferred to the destination wallet identified by the transfer destination identifier 112. In other examples, the transfer destination and/or the transfer destination can be accounts with banks or other financial institutions, or any other type of account or entity that may hold and/or transfer funds.

The blockchain 104 can be a distributed ledger implemented via multiple decentralized computing devices known as nodes. Each node can store a copy of the blockchain 104. The blockchain 104 can include multiple blocks 114 that are linked together in sequence, such as block 114A, block 114B, and block 114C shown in FIG. 1. New blocks 114 can be added to the blockchain 104, for instance if the nodes process potential new blocks 114 and reach a consensus indicating that the new blocks 114 should be added to the blockchain 104.

Each of the blocks 114 in the blockchain 104 can store its own unique data. For example, the smart contract 102 for a particular life insurance policy may be stored in block 114B as shown in FIG. 1. Different blocks 114 in the blockchain 104 may store different smart contracts 102 for different life insurance policies, store different types of smart contracts 102, or store other types of information. Each of the blocks 114 can also store a block hash 116 that cryptographically reflects the data stored within the block 114 itself, such as the smart contract 102, as well as data stored in the preceding block 114 in the blockchain 104. For example, in FIG. 1, the block hash 116 stored in block 114B can be computed based on data stored in block 114A, such as both a block hash stored within block 114A and other data stored in block 114A. Because the block hash 116 in each block 114 is based in part on data stored in the preceding block 114, thereby linking the blocks 114 together, data stored in the blockchain 104 can be trusted because any changes to a particular block 114 would not be reflected by the block hashes of subsequent blocks 114 in the blockchain 104. Accordingly, once the smart contract 102 is created and added to the blockchain 104, the smart contract 102 can be static and/unmodifiable, such that the smart contract 102 will automatically execute via the blockchain 104 when the execution conditions 108 of the smart contract 102 are met.

The blockchain 104 can be a type of blockchain that is configured to automatically execute smart contracts 102, such as an Ethereum® blockchain. In some examples, the transfer source and/or the transfer destination associated with the smart contract 102 can be cryptocurrency wallets that can store amounts of cryptocurrency, such as a type of cryptocurrency used on the blockchain 104. As an example, if the blockchain 104 is an Ethereum® blockchain, the transfer source and/or the transfer destination associated with the smart contract 102 can be cryptocurrency wallets that can store amounts of Ether®, a cryptocurrency used on the Ethereum® blockchain.

A policy management system 118 can be configured to generate and/or manage the smart contract 102. For example, the policy management system 118 may be a website, a mobile application, or other type of computer-executable application or system that a user can use via a user device 120. In some examples, the user may be an individual that desires to sign up for a life insurance policy, and to become the policyholder associated with the life insurance policy. In other examples, the user may an insurance agent or other third party who assists another person with setting up a life insurance policy that will cover the other person as a policyholder.

The user can use the user device 120, such as a personal computer, smartphone, tablet computer, or other type of computing device to interact with the policy management system 118 and provide user input 122 to the policy management system 118, for instance via the Internet or another network connection. In some examples, some portions of the policy management system 118 may execute on and/or be accessed by the user device 120, while other portions of the policy management system 118 may execute remotely from the user device 120 via one or more servers associated with an insurance company, via computing resources of a cloud computing environment, or via other computing resources. For example, a user interface of the policy management system 118 may be displayed via the user device 120, while user input 122 provided by the user device 120 via the user interface may be processed by portions of the policy management system 118 that execute on the user device 120 and/or on other computing systems remote from the user device 120.

The user can provide user input 122 indicating information about a life insurance policy, which the policy management system 118 can use to generate the smart contract 102 for the life insurance policy on the blockchain 104. As an example, the user input 122 can provide an age and/or birthdate of the policyholder that will be covered by the smart contract 102.

As another example, the user input 122 can also, or alternately, provide a policyholder identifier that identifies the policyholder that will be covered by the smart contract 102. A policyholder identifier, provided as user input 122 and used in association with the smart contract 102, can be an identification number that uniquely identifies the policyholder to a national government, a local government, or other entity. For example, the policyholder identifier can be a Social Security Number (SSN) that identifies the policyholder in the United States. As another example, in other countries the policyholder identifier may be a different type of national identification number.

The policyholder identifier, provided as user input 122 and used in association with the smart contract 102, can be a type of identifier that is used within death notices 106, death records, and/or other information stored in a death record repository 124 maintained by a government or other entity. As an example, the death record repository 124 can be the Social Security Death Index (SSDI) maintained by the Social Security Administration (SSA) in the United States. The SSDI can be a database or other repository of death records that lists SSNs of individuals who have died. Accordingly, when local authorities or other entries verify that a person has died, the SSA can be notified such that the SSA can add a death record indicating the deceased person's SSN to the SSDI. In other examples, other countries or jurisdictions can maintain similar databases of repositories of death records that use other types of identification numbers to identify deceased persons.

As described herein, the policy management system 118, the smart contract 102, and/or a separate system may execute a death notice tracker 126 that is configured to identify death records of new deaths that have been added to the death record repository 124. The death notice tracker 126 can be configured to retrieve or generate corresponding death notices 106, such as the death notice 106 shown in FIG. 1, that identify SSNs and/or other identifiers of deceased individuals based on the death records stored in the death record repository 124. The death notice tracker 126 may receive death notices 106 provided by the death record repository 124, and/or may generate death notices 106 based on corresponding death records added to the death record repository 124. In some examples, the death notice tracker 126 may be configured to scan the death record repository 124 for new death records or corresponding death notices 106 continuously, once per hour, once per day, or on any other regular or irregular schedule. In other examples, the death notice tracker 126 may subscribe to a stream of new death notices 106 provided by the death record repository 124. As described herein, a death notice that indicates, via an SSN or other identifier, that a policyholder associated with a life insurance policy has died can be used as a trigger that initiates automatic execution of a corresponding smart contract 102 in the blockchain 104, such that funds are automatically transferred from a transfer source to a transfer destination in response to the death of the policyholder.

In some examples, the policy management system 118 can have an input validator 128 that is configured to validate one or more types of user input 122 before the policy management system 118 uses the user input 122 to generate the smart contract 102. The input validator 128 can, for example, validate that one or more types of user input 122 match expected formats, data types, and/or value ranges. The input validator 128 can also, in some examples, determine whether values of one or more types of user input 122 qualify for a life insurance policy. As a non-limiting example, an insurance company may indicate that a type of life insurance policy is only available to policyholders who are at least 55 years old. Accordingly, in this example, the input validator 128 can use user input 122 provided by a potential policyholder to verify that the potential policyholder is at least 55 years old before the policy management system 118 generates a corresponding smart contract 102 and/or adds the corresponding smart contract 102 to the blockchain 104.

The input validator 128 can, in some examples, be configured to use zero-knowledge proofs to validate one or more types of user input 122 and/or to verify that a potential policyholder qualifies for a life insurance policy based on that user input 122. Zero-knowledge proofs can be used to verify information without the information itself being provided. In some examples, the input validator 128 can interact with one or more third-party databases or systems, for instance via the Internet or other network connections, to verify information based on zero-knowledge proofs.

In some examples, one or more types of information may be indicated by provided user input 122, but the provided user input 122 may omit one or more other types of information that could be used to validate the provided user input 122 and/or to verify that a potential policyholder qualifies for a life insurance policy. However, the input validator 128 can be configured to use information that was provided in the user input 122 to verify one or more other types of information that were not provided in the user input 122, without directly obtaining or determining those other types of information.

As a non-limiting example, if an insurance company makes a certain type of life insurance policy available only to policyholders who are at least 55 years old as discussed in an example above, a potential policyholder may provide their SSN in user input 122, but avoid providing their age or birthdate in the user input 122. The input validator 128 may verify that the provided SSN is a valid SSN, for instance by securely providing the SSN to an SSA database or other database of valid SSNs. The input validator 128 may also use a zero-knowledge proofs to verify that the provided SSN identifies a person who is at least 55 years of age. Accordingly, the input validator 128 can confirm that the person is at least 55 years of age without ever obtaining or determining information that directly identifies the person's exact age or birthdate. For instance, the input validator 128 may securely provide the SSN provided by the potential policyholder to an SSA database or other outside database that matches SSNs with birthdates and/or ages. The outside database may return information to the input validator 128 confirming that the person associated with the provided SSN is at least 55 years of age, but not return information indicating the person's exact age or birthdate. Accordingly, the input validator 128 can use zero-knowledge proofs to confirm that the potential policyholder identified by a provided SSN is at least 55 years of age and thus qualifies for the particular type of life insurance policy, without ever determining the potential policyholder's exact age or birthdate.

In some examples, the user input 122 can also provide the transfer source identifier 110 and/or the transfer destination identifier 112 to be associated with the life insurance policy and the smart contract 102. As described herein, when the death notice 106 indicating the death of the policyholder is identified by the death notice tracker 126 based on the death record repository 124, the smart contract 102 can automatically execute in the blockchain 104 to transfer funds from a transfer source identified by the transfer source identifier 110 to a transfer destination identified by the transfer destination identifier 112.

The transfer source and/or the transfer destination can, in some examples, be cryptocurrency wallets that are stored on the same blockchain 104 as the smart contract 102, or on a different blockchain. Accordingly, the transfer source identifier 110 can be an address of a first cryptocurrency wallet that is to be used as a funding wallet associated with the life insurance policy, and the transfer destination identifier 112 can be an address of a second cryptocurrency wallet that is to be used as a destination wallet associated with the life insurance policy. As an example, the transfer source and/or the transfer destination can be cryptocurrency wallets that store amounts of Ether®, a cryptocurrency used on the Ethereum® blockchain, and the transfer source identifier 110 and the transfer destination identifier 112 can addresses of corresponding Ether® wallets.

In some examples, the transfer source identifier 110 identifying the transfer source can be provided via user input 122. For example, a potential policyholder may set up a cryptocurrency funding wallet to be used as the transfer source, and may provide an address of the funding wallet in the user input 122. The potential policyholder may transfer funds into the funding wallet, for instance by storing an up-front payment of cryptocurrency in the funding wallet and/or periodically or occasionally transferring amounts of cryptocurrency into the funding wallet.

In other examples, an insurance company or other entity may maintain or manage the transfer source, such as a new funding cryptocurrency wallet set up for a single life insurance policy or an existing funding cryptocurrency wallet that can be used as the transfer source for multiple life insurance policies. In these examples, the insurance company or other entity may receive one or more life insurance premium payments from a bank account or other funding source of the policyholder, and may transfer at least a portion of the premium payments to the cryptocurrency wallet designated as the transfer source. Accordingly, in these examples, the user input 122 can omit the transfer source identifier 110, and the policy management system 118 can provide a transfer source identifier 110 of a new or existing cryptocurrency wallet that is to be used as the transfer source associated with the life insurance policy.

In some examples, the transfer destination identifier 112 identifying the transfer destination can also, or alternately, be provided via user input 122. For example, a potential policyholder may set up a cryptocurrency destination wallet to be used as the transfer destination, and may provide an address of the destination wallet in the user input 122. As another example, a beneficiary to be associated with the life insurance policy may set up a cryptocurrency destination wallet, and the potential policyholder may provide an address of the beneficiary's destination wallet in the user input 122. In still other examples, an insurance company or other entity may set up a cryptocurrency destination wallet to be associated with the life insurance policy, such that the user input 122 can omit the transfer destination identifier 112, and the policy management system 118 can provide a transfer destination identifier 112 of the destination wallet that is to be used as the transfer destination associated with the life insurance policy.

As discussed above, because the transfer destination may be a destination cryptocurrency wallet, the transfer destination may be accessed by any party that has cryptographic keys associated with the destination cryptocurrency wallet. In some examples, the destination cryptocurrency wallet designated as the transfer destination may have been set up by a particular beneficiary. Accordingly, the beneficiary can have cryptographic keys associated with the destination cryptocurrency wallet, and the beneficiary can use those cryptographic keys to access funds transferred to the destination cryptocurrency wallet upon the death of the policyholder. However, in other examples, the destination cryptocurrency wallet may not be associated with a particular beneficiary. For instance, the destination cryptocurrency wallet may be set up by the policyholder, an insurance company, or other entity such that anyone who has the corresponding cryptographic keys can access funds stored in the destination cryptocurrency wallet. Accordingly, anyone who has, or is given, the cryptographic keys for the destination cryptocurrency wallet can access a life insurance payment that is transferred to the destination cryptocurrency wallet from the transfer source, such as a funding cryptocurrency wallet, upon the death of the policyholder.

As an example, the policyholder may set up the destination cryptocurrency wallet and obtain the corresponding cryptographic keys for the destination cryptocurrency wallet. In some cases, the policyholder may then give the cryptographic keys to a person who the policyholder wants to be the beneficiary of the life insurance policy, such that the beneficiary can use the cryptographic keys to access funds that are transferred to the destination cryptocurrency wallet upon the death of the policyholder. In other cases, the policyholder may give the cryptographic keys to an executor named in the policyholder's will, to a trustee who manages a trust associated with the policyholder, or to another party who is trusted by the policyholder to manage the cryptographic keys associated with the destination cryptocurrency wallet. Upon the death of the policyholder, funds can be automatically transferred to the destination cryptocurrency wallet via the smart contract 102 as described herein. The party who has been trusted to manage the cryptographic keys associated with the destination cryptocurrency wallet can accordingly give the cryptographic keys to a party that is determined to be the appropriate recipient of the life insurance payment upon the policyholder's death, such as a person named in the policyholder's will. The party that receives the cryptographic keys associated with the destination cryptocurrency wallet can accordingly access the funds that are transferred to the destination cryptocurrency wallet upon the death of the policyholder.

As another example, an insurance company or other entity, such as a third-party wallet service, may set up the destination cryptocurrency wallet and obtain the corresponding cryptographic keys. The insurance company or other entity may provide a beneficiary manager 130, such as an automated computer-implemented system, that allows the policyholder to designate and/or change a beneficiary for the life insurance policy. In some examples, the beneficiary manager 130 may be a component of the policy management system 118. In other examples, the beneficiary manager 130 may be a separate component that may be provided and/or accessed outside the policy management system 118.

The beneficiary manager 130 may have a user interface or other interface that allows a policyholder to provide user input 122 identifying a name and/or contact information for a beneficiary to be associated with a life insurance policy represented by a smart contract 102. However, the beneficiary manager 130 may store the name and/or contact information for the beneficiary separately from the smart contract 102, such as in a local database or other data repository different from the smart contract 102. As discussed above, the smart contract 102 representing the life insurance policy may indicate a transfer destination identifier 112, such as an address or identifier of a destination cryptocurrency wallet, instead of directly identifying a particular beneficiary of the life insurance policy. However, identifying information about the current beneficiary of the life insurance policy may be maintained separately in records maintained by the beneficiary manager 130. The beneficiary manager 130 may also allow the policyholder to optionally change the beneficiary information associated with the life insurance policy in local records or other information that is stored by the beneficiary manager 130 separately from the smart contract 102.

Upon the death of the policyholder, funds can be automatically transferred to a destination cryptocurrency wallet via execution of the smart contract 102, as described herein. The beneficiary manager 130 can accordingly send a notification to the party who is identified, by the information stored by the beneficiary manager 130 separately from the smart contract 102, as the current beneficiary after receipt of the death notice 106 indicating the policyholder's death. The beneficiary manager 130 can also, or alternately, provide the cryptographic keys associated with the destination cryptocurrency wallet to the party who is identified as the current beneficiary by the information stored by the beneficiary manager 130 separately from the smart contract 102. Accordingly, that party can use the cryptographic keys provided by the beneficiary manager 130 to access the funds that are separately and automatically transferred to the destination cryptocurrency wallet upon the death of the policyholder based on automatic execution of the smart contract 102.

In the examples discussed above, the transfer destination identifier 112 of a destination cryptocurrency wallet associated with the smart contract 102 can remain the same until the policyholder's death. However, cryptographic keys that grant access to that destination cryptocurrency wallet can be passed between parties in order to change who can access funds transferred to the destination cryptocurrency wallet after the policyholder's death.

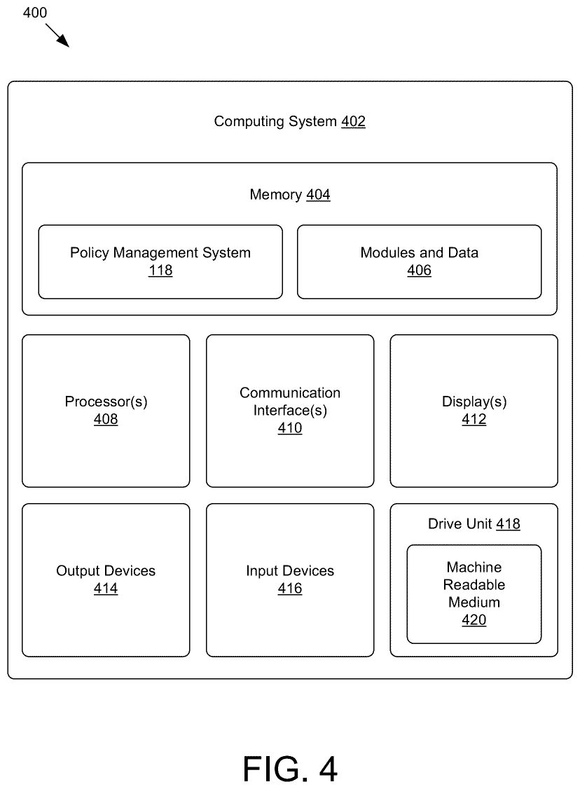

In some examples, the death notice tracker 126, the input validator 128, and the beneficiary manager 130 can be part of, and/or be implemented by, the policy management system 118. However, in other examples, one or more of the death notice tracker 126, the input validator 128, and the beneficiary manager 130 can be implemented by separate and/or different computing systems. As a non-limiting example, the input validator 128 may be part of the policy management system 118, but the death notice tracker 126 and/or the beneficiary manager 130 can be implemented via one or more separate systems and/or computing devices. An example of computing architecture that can be used to implement the policy management system 118, and/or separate instances of the death notice tracker 126, the input validator 128, and the beneficiary manager 130, is shown in FIG. 4 and is discussed further below with respect to that figure. In other examples, the smart contract 102 can include an instance of the death notice tracker 126 that is configured to periodically or occasionally search for a death notice 106 that matches a particular SSN or policyholder identifier. Accordingly, in these examples, the instance of the death notice tracker 126 can execute as part of the smart contract 102 via one or more nodes that host the blockchain 104. For instance, the smart contract 102 stored in the blockchain 104 may periodically or occasionally execute to search, via an instance of the death notice tracker 126, for a matching death notice 106 in the death record repository 124.

Based on receipt and/or validation of user input 122 as discussed above, and identification of the transfer source identifier 110 and transfer destination identifier 112, the policy management system 118 can automatically generate a smart contract 102 for a corresponding life insurance policy. For example, the policy management system 118 can use templates of pre-written code, generative systems, and/or other mechanisms to automatically generate computer-executable instructions for the smart contract 102 based on the user input 122, the transfer source identifier 110, the transfer destination identifier 112, and/or other information described herein.

The computer-executable instructions for the smart contract 102 can define execution conditions 108 indicating when the smart contract 102 is to be executed, operations to be performed automatically during execution of the smart contract 102, and/or other information associated with execution of the smart contract 102. For example, the execution conditions 108 for the smart contract 102 can indicate that when a death notice 106, identified by the death notice tracker 126 based on the death record repository 124, indicates that the policyholder has died, funds are to be automatically transferred from the transfer source identified by the transfer source identifier 110 to the transfer destination identified by the transfer destination identifier 112. Accordingly, when the death notice 106 indicating the death of the policyholder is identified, the computer-executable instructions for the smart contract 102 can execute within the blockchain 104 to automatically implement a corresponding transfer from the identified transfer source to the identified transfer destination.

In some examples, the user input 122 and/or execution conditions 108 may define a particular amount of funds to be automatically transferred from the transfer source to the transfer destination upon the death of the policyholder. However, in other examples, the user input 122 and/or execution conditions 108 may indicate that all of the funds in the transfer source are to be transferred to the transfer destination upon the death of the policyholder. For example, if the transfer source and the destination source are cryptocurrency wallets, automatic execution of the smart contract 102 in response the death notice 106 indicating the death of the policyholder can cause all of the cryptocurrency to be automatically transferred from the identified funding cryptocurrency wallet to the identified destination cryptocurrency wallet.

In some examples, the execution conditions 108 defined in the smart contract 102 may indicate, in a secure and/or encrypted form, the policyholder identifier of the policyholder. For example, if the policyholder's SSN is provided in the user input 122, the policy management system 118 may generate a hash value that corresponds with the policyholder's SSN. The policy management system 118 may indicate that hash value in the execution conditions 108 of the smart contract 102, instead of indicating the policyholder's SSN in the smart contract 102 directly, in order to avoid exposing the policyholder's SSN on the blockchain 104. When the death notice tracker 126 identifies a death notice 106 associated with an SSN, the death notice tracker 126 may transmit a notification associated with the death notice 106 to the blockchain 104. In some examples, the notification may indicate the SSN in an unencrypted form, and nodes on the blockchain 104 may generate a hashed version of the SSN in order to determine whether the hashed version of the SSN matches execution conditions 108 of a smart contract 102 stored in the blockchain 104. In other examples, the death notice tracker 126 may generate a hashed version of the SSN and transmit a notification associated with the death notice 106 to the blockchain 104 that includes the hashed version of the SSN. Accordingly, nodes on the blockchain 104 can determine whether the hashed version of the SSN provided by the death notice tracker 126 matches execution conditions 108 of a smart contract 102 stored in the blockchain 104.

In other examples, the death notice tracker 126 and/or other elements of the policy management system 118 can store local records that securely identify SSNs or other policyholder identifiers of policyholders known to be associated with corresponding smart contracts 102. For instance, smart contracts 102 generated by the policy management system 118 and added to the blockchain 104 may indicate, in execution conditions 108 or other data, unique identifiers of the smart contracts 102 or corresponding life insurance policies. The policy management system 118 can have, or can access, a database that stores SSNs and/or other policyholder identifiers of policyholders that are associated with the life insurance policies. The database may be a local database or another data repository that separate from the blockchain 104, such that the SSNs and/or other policyholder identifiers of policyholders associated with the life insurance policies are not stored in the blockchain 104. The database may also map the policyholder identifiers to identifiers of corresponding smart contracts 102 and/or corresponding life insurance policies.

Accordingly, the death notice tracker 126 may identify a death notice that includes an SSN or other identifier that, based on a database or other records maintained separately from the blockchain 104, is associated with policyholder who holds a life insurance policy represented by a smart contract. In this situation, the death notice tracker 126 can send a version of the death notice 106, or a separate trigger notification, to the blockchain 104 that indicates the identifier of the particular smart contract or life insurance policy associated with the policyholder, but that omits the policyholder's SSN or other policyholder identifier. This version of the death notice 106, or the separate trigger notification, that is sent based on separately-stored records about policyholder identifiers can accordingly cause execution of the smart contract 102 without the policyholder's SSN or other identifier being stored in the smart contract 102 on the blockchain 104 or being sent in a death notice 106 to the blockchain 104.

In still other examples, an instance of the death notice tracker 126 can be incorporated into the smart contract 102 on the blockchain 104. For example, an instance of the death notice tracker 126, configured to identify when a death notice 106 associated with a particular SSN or other policyholder identifier is added to the death record repository 124, can be integrated into computer-executable instructions and/or other code of the smart contract 102. Accordingly, that instance of the death notice tracker 126 may periodically check the death record repository 124 for a death notice 106 associated with the particular SSN or other policyholder. When that death notice 106 is received or identified, the death notice tracker 126 in the smart contract 102 can determine that the execution conditions 108 have been met, and can accordingly cause the automatic execution of the smart contract 102.

Overall, the life insurance system 100 can be a fully automated end-to-end system that automatically creates the smart contract 102 based on provided data, automatically adds the smart contract 102 to the blockchain 104, and automatically executes the smart contract 102 in the blockchain 104 upon the death of the policyholder. For example, when a policyholder dies and a corresponding death record is added to the death record repository 124, the death notice tracker 126 can automatically identify the death record or a corresponding death notice 106 based on the death record repository 124. The death notice tracker 126 can also provide the death notice 106, or a corresponding notification, to nodes that execute the blockchain 104. Accordingly, if the death notice 106 or corresponding notification indicates a policyholder identifier or other identifier that matches the execution conditions 108 of a smart contract 102 for life insurance that is stored in a block 114 of the blockchain, the smart contract 102 can automatically execute on the blockchain 104. Automatic execution of the smart contract 102 can cause funds to be automatically transferred from the transfer source identified by the transfer source identifier 110 in the smart contract 102 to the transfer destination identified by the transfer destination identifier 112 in the smart contract 102. The amount of the transferred funds may be based on a predefined amount indicated in the execution conditions 108, or may be based on an amount of funds stored in or available at the transfer source at the time the automatic transfer occurs. Because the transfer source and the transfer destination may be cryptocurrency wallets, cryptocurrency can be transferred between the cryptocurrency wallets via the blockchain 104 automatically and substantially immediately based on automatic execution of the smart contract 102 in the blockchain 104.

Accordingly, when a policyholder of a life insurance policy represented by a smart contract 102 dies and a corresponding death notice 106 is identified based on the death record repository 124, the smart contract 102 can execute automatically and substantially immediately to transfer funds to the transfer destination identified in the smart contract 102. A person or other entity who has, or is given, access to the transfer destination can immediately access the funds that have been automatically transferred to the transfer destination due to the automatic execution of the smart contract 102. The smart contract 102 can therefore lead to a payment being automatically and/or immediately transferred to the transfer destination upon a death notice 106 indicating the death of the policyholder, such that a beneficiary can avoid needing to file an insurance claim with an insurance company, waiting for the insurance company to process the insurance claim, and waiting for payment networks and financial institutions to transfer funds once the insurance claim is approved.

Accordingly, relative to conventional systems in which computing resources and personnel of an insurance company would be used to receive and process life insurance claims, automatically administering life insurance policies via smart contracts 102 on the blockchain can reduce the overall amount of insurance claims handled by the insurance company. Such a reduction in the overall number of insurance claims handled by the insurance company can also reduce the amount of network bandwidth, computing cycles, computer memory, and other computing resources used in association with processing insurance claims. For example, if an insurance claim for a conventional life insurance policy is submitted to computer systems of an insurance company, the computer systems of the insurance company may use bandwidth resources, processing cycles, memory, and/or other computing resources to receive data, store data, transport data, and/or to otherwise process data associated with the insurance claim. However, as described herein, the smart contract 102 in the blockchain 104 may execute automatically to cause an automatic transfer of funds associated with a life insurance policy, and thereby avoid submission of an insurance claim to an insurance claim that would otherwise lead to the consumption of computing resources of an insurance company.

Moreover, payments associated with life insurance policies represented by smart contracts 102 on the blockchain 104 can be made automatically and substantially immediately in response to death notices 106, without human involvement. Accordingly, such automatic payments associated with life insurance policies that are made automatically via smart contracts 102 on the blockchain 104 can be made more quickly than conventional life insurance payments that would be made based on insurance claims submitted to an insurance company after the insurance company manually or automatically evaluates the insurance claims over longer periods of time.

Additionally, because smart contracts 102 can be unmodifiable once they have been added to the blockchain 104, and because corresponding payments can be made automatically and substantially immediately in response to death notices 106, without human involvement, the smart contracts 102 can reduce the risk of error associated with administering life insurance policies and processing life insurance policies. For example, while payments associated with conventional life insurance policies may be held up or misdirected due to processing errors and/or human error in some situations, payments made via execution of smart contract 102 in the blockchain 104 can be made automatically based on the transfer source identifiers 110 and the transfer destination identifiers 112 indicated directly in the computer-executable instructions associated with the smart contracts 102.

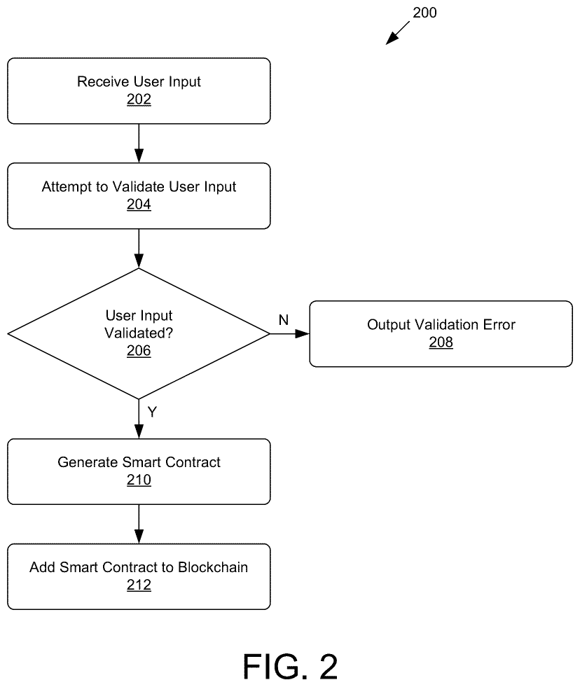

FIG. 2 shows a flowchart illustrating an example method 200 for generating a smart contract 102 for a life insurance policy on the blockchain 104. The method 200 shown in FIG. 2 can be performed by a computing system that is configured to execute the policy management system 118. An example system architecture for such a computing system is described below with respect to FIG. 4.

At operation 202, the policy management system 118 can receive user input 122 associated with a life insurance policy. For example, the user input 122 can be received from a user device 120 operated by a potential policyholder who is to be covered by the life insurance policy. The user input 122 can, for example, indicate an age or birthdate associated with the potential policyholder, an SSN or other policyholder identifier associated with the potential policyholder, and/or any other information about the life insurance policy. In some examples, the user input 122 may also provide a transfer source identifier 110 of a transfer source, such as a funding cryptocurrency wallet, to be associated with the life insurance policy. In some examples, the user input 122 may also or alternately provide a transfer destination identifier 112 of a transfer destination, such as a destination cryptocurrency wallet, to be associated with the life insurance policy. In some examples, the user input 122 may also or alternately indicate a particular payment amount to be transferred in association with the life insurance policy upon the death of the policyholder, or whether all funds available at a transfer source is to be transferred to a transfer destination are to be transferred in association with the life insurance policy upon the death of the policyholder.

At operation 204, the policy management system 118 can attempt to validate the user input 122 received at operation 202. For example, the input validator 128 of the policy management system 118 may verify an SSN provided in the user input 122 with an SSN database to validate that the provided SSN is a valid SSN. In some examples, the input validator 128 of the policy management system 118 may also use zero-knowledge proofs to validate one or more types of user input 122 and/to validate other types of information based on the user input 122. For example, the input validator 128 can use a zero-knowledge proof to verify that the age of the individual identified by a provided and/or validated SSN is equal to or above a threshold age, and thus qualifies for a type of life insurance to be represented via the smart contract 102 on the blockchain 104.

At operation 206, the policy management system 118 can determine whether the user input 122 was validated at operation 204. If the user input 122 was not validated (Operation 206—No), the policy management system 118 may output a validation error at operation 208. For example, a user interface of the policy management system 118 may display an error indicating that the user input 122 received from the user at operation 202 was found to be invalid and/or did not qualify the user to obtain a life insurance policy. In some examples, the user may attempt to correct any errors by providing new and/or corrected user input at operation 202, which the policy management system 118 may attempt to validate at operation 206.

However, if the user input 122 provided at operation 202 is validated at operation 204 (Operation 206—Yes), the policy management system 118 can generate the smart contract 102 at operation 210. For example, the policy management system 118 can automatically generate code for the smart contract 102 that can execute on the blockchain 104. The code for the smart contract 102 may be computer-executable instructions that may be executed via the blockchain 104, for instance via nodes of the blockchain 104. The policy management system 118 may generate the smart contract 102 at operation 210 based on templates of pre-written source code, scripts, or other computer-executable instructions that may be filled in based on values provided in user input 122 and/or other data, based on generative systems in response to provided user input 122 and/or validations of the user input 122, and/or based on other systems.

The computer-executable instructions may define execution conditions 108 indicating how and/or when the smart contract 102 is to automatically execute, and/or indicating operations to be performed automatically during execution of the smart contract 102. The execution conditions 108 can, for example, include an identifier of the life insurance policy and/or the policyholder identification number associated with the smart contract 102. Such an identifier of the life insurance policy and/or the policyholder identification number may, in some examples, be encoded into code of the smart contract 102 in a hashed form. The execution conditions 108 can also indicate that when a death notice 106 indicates that the policyholder, associated with the identifier of the life insurance policy and/or the policyholder identification number, has died, a payment will be automatically transferred from the transfer source identified by the transfer source identifier 110 to the transfer destination identified by the transfer destination identifier 112.

In some examples, the smart contract 102 can also be encoded with an instance of the death notice tracker 126 that is configured to execute in the blockchain 104 to check the death record repository 124 for a death notice 106 that includes the policyholder identification number associated with the smart contract 102. In other examples, an instance of the death notice tracker 126 can execute via the policy management system 118 or another separate system, but the smart contract 102 can be coded to automatically execute when the separate instance death notice tracker 126 provides, to the blockchain 104, a copy of a death notice 106 or other notification that includes the identifier of the life insurance policy and/or the policyholder identification number.

After the smart contract 102 is generated at operation 210, the policy management system 118 can add the smart contract 102 to the blockchain 104 at operation 212. For example, the policy management system 118 can provide the smart contract 102 to one or more nodes that host the blockchain 104, such that the hosts can come to a consensus and add the smart contract 102 to a new block 114 in the blockchain 104. As discussed above, the new block 114 that represents the smart contract 102 can have a block hash 116 that is based at least in part on the contents of the new block 114 and the preceding block 114 in the blockchain 104. Similarly, a subsequent block 114 that is later added to the blockchain 104 would have a block hash that is based in part on the contents of the block 114 that represents the smart contract 102. Accordingly, any modifications to the smart contract 102 can be identified and/or disallowed because the block hashes of the block 114 would no longer correspond to the contents of other blocks in the blockchain 104.

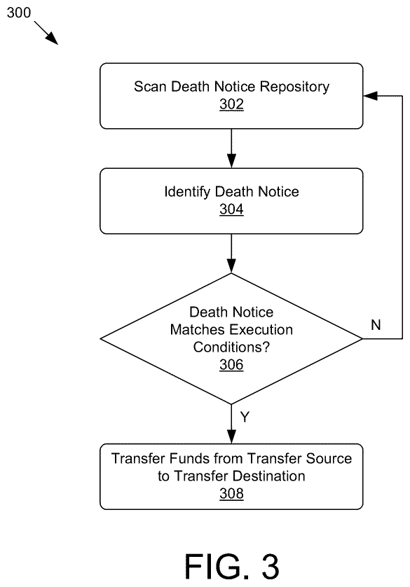

After the smart contract 102 for the life insurance policy is added to the blockchain 104 at operation 212, a death notice tracker 126 in the smart contract 102 and/or at a separate system can monitor for a death notice 106 that is associated with the life insurance policy, such that the smart contract 102 can automatically execute in response to the death notice 106. An example method of automatically executing the smart contract 102 in response to such a death notice 106 is discussed further below with respect to FIG. 3.

FIG. 3 shows a flowchart illustrating an example method 300 for automatically executing a smart contract 102 for a life insurance policy on the blockchain 104, based on a corresponding death notice 106. The method 300 shown in FIG. 3 can be performed by a computing system that is configured to execute an instance of the death notice tracker 126 and/or to execute the smart contract 102 within the blockchain 104. An example system architecture for such a computing system is described below with respect to FIG. 4.

At operation 302, the death notice tracker 126 can scan the death record repository 124 for new death records, and may identify a death notice 106 at operation 304 based on the death record repository 124. In some examples, the death notice tracker 126 may continuously, periodically, or occasionally scan the death record repository 124 for new death records that have been added to the death record repository 124 since the last scan, and can generate corresponding death notices 106. In other examples, the death notice tracker 126 may subscribe to death notices 106 produced and/or output by the death record repository 124.

In some examples, the death notice tracker 126 may be configured to identify death notices 106 that correspond to SSNs or other policyholder identifiers that are stored in a local database or other records associated with known life insurance policies that are stored separately outside the blockchain 104. In these examples, the death notice tracker 126 may use such separately-stored information to identify death notices 106 and/or death records in the death record repository 124 that specify SSNs or other policyholder identifiers that are associated with the known life insurance policies. The death notice tracker 126 may accordingly transmit corresponding death notices or other notifications to nodes that host the blockchain 104.

In other examples, the death notice tracker 126 may be configured to identify death notices 106 for any or all new death records added to the death record repository 124. In these examples, the death notice tracker 126 may transmit corresponding death notices 106 or other notifications to nodes that host the blockchain 104.

In still other examples, the death notice tracker 126 may be encoded into the smart contract 102 that is associated with a particular policyholder. The encoded death notice tracker 126 may be configured to execute, in the blockchain 104, to search the death record repository 124 for a death record or death notice 106 that specifies a particular SSN or other policyholder identifier associated with that particular policyholder, for instance based on execution conditions 108 defined by computer-executable instructions associated with the smart contract 102.

Accordingly, at operation 306, the blockchain 104 can determine whether the death notice 106 identified at operation 304 matches the execution conditions 108 defined in computer-executable instructions of the smart contract 102. For example, the blockchain 104, via a node that executes the blockchain 104, can determine whether an SSN or other policyholder identifier indicated by the death notice matches an SSN or other policyholder identifier indicated in the execution conditions 108. As described above, in some examples the death notice 106 and/or the execution conditions 108 may represent the SSN or other policyholder identifier in a hashed or secure form. In other examples, the death notice tracker 126 may have a database outside the blockchain 104 that separately stores SSNs or other policyholder identifiers known to be associated with smart contracts 102, and that maps the SSNs or other policyholder identifiers to other identifiers that represent the smart contracts 102. Accordingly, the death notice tracker 126 may provide the blockchain 104 with an identifier of the smart contract 102 associated with an SSN or other policyholder identifier that was indicated in a death notice 106, in lieu of providing the SSN or other policyholder identifier directly or in a hashed form.

If the death notice 106 identified at operation 304 does not match the execution conditions 108 defined in the smart contract 102 (Operation 306-No), the death notice tracker 126 can continue scanning the death record repository 124 at operation 302 in order to find a death notice 106 that satisfies the execution conditions 108 defined in the smart contract 102 when the policyholder eventually dies. However, if the death notice 106 identified at operation 304 does match the execution conditions 108 defined in the smart contract 102 (Operation 306—Yes), the smart contract 102 can automatically execute in the blockchain 104 at operation 308.

For example, at operation 308, the blockchain 104 can respond to determining that the death notice 106 is a match for the execution conditions 108 of the smart contract 102 by automatically implementing a transfer of funds from a transfer source to a transfer destination. The transfer source may be identified by the transfer source identifier 110 defined in the computer-executable instructions of the smart contract 102, and the transfer destination may be similarly identified by the transfer destination identifier 112 defined in the computer-executable instructions of the smart contract 102. As discussed above, the transfer source and the transfer destination may be cryptocurrency wallets that are also implemented via the blockchain 104. Accordingly, the blockchain 104 may cause a transfer of funds between the cryptocurrency wallets to occur automatically and substantially immediately at operation 308 in response to determining at operation 306 that the death notice 106 matches the execution conditions 108 of the smart contract 102.

FIG. 4 shows an example system architecture 400 for a computing system 402 that can execute one or more elements associated with smart contracts 102 for life insurance on the blockchain 104 as described herein. In some examples, the computing system 402 may execute one or more of the death notice tracker 126, the input validator 128, the beneficiary manager 130, or other elements of the policy management system 118. In other examples, the computing system 402 may be an instance of the user device 120. In still other examples, the computing system 402 may be a computing node that executes and/or hosts a copy of the blockchain 104. The computing system 402 can include one or more computers, servers, or other types of computing devices. Individual computing devices of the computing system 402 may have the system architecture 400 shown in FIG. 4, or a similar system architecture.

In some examples, elements associated with smart contracts 102 for life insurance on the blockchain 104 can be distributed among, and/or be executed by, multiple computing systems or devices similar to the computing system 402 shown in FIG. 4. As an example, the death notice tracker 126 and the input validator 128 may be executed by different computing devices and/or computing systems. In some examples, elements of the computing system 402 may, in some examples, be part of a cloud computing environment or other distributed system that hosts and/or executes one or more elements associated with smart contracts for life insurance on the blockchain 104.

The computing system 402 can include memory 404. In various examples, the memory 404 can include system memory, which may be volatile (such as RAM), non-volatile (such as ROM, flash memory, etc.) or some combination of the two. The memory 404 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 402. Any such non-transitory computer-readable media may be part of the computing system 402.

The memory 404 can store modules and data 406, including software or firmware elements, such as data and/or computer-readable instructions that are executable by one or more processors 408. For example, the memory 404 can store computer-executable instructions and data associated with the policy management system 118, such as data associated with one or more of the death notice tracker 126, the input validator 128, or the beneficiary manager 130. The modules and data 406 stored in the memory 404 can also include any other modules and/or data that can be utilized by the computing system 402 to perform or enable performing any action taken by the computing system 402. Such modules and data 406 can include a platform, operating system, and applications, and data utilized by the platform, operating system, and applications.

The computing system 402 can also have processor(s) 408, communication interfaces 410, a display 412, output devices 414, input devices 416, and/or a drive unit 418 including a machine readable medium 420.

In various examples, the processor(s) 408 can be a central processing unit (CPU), a graphics processing unit (GPU), both a CPU and a GPU, or any other type of processing unit. Each of the one or more processor(s) 408 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 408 may also be responsible for executing computer applications stored in the memory 404, which can be associated with types of volatile (RAM) and/or nonvolatile (ROM) memory.

The communication interfaces 410 can include transceivers, modems, network interfaces, antennas, and/or other components that can transmit and/or receive data over networks or other connections. In some examples, the communication interfaces 410 can be used to exchange data between elements described herein, such as communications between the policy management system 118 and/or the death notice tracker 126 and the death record repository 124, the user device 120, and nodes that host the blockchain 104.

The display 412 can be a liquid crystal display, or any other type of display commonly used in computing devices. The output devices 414 can include any sort of output devices known in the art, such as the display 412, speakers, a vibrating mechanism, and/or a tactile feedback mechanism. Output devices 414 can also include ports for one or more peripheral devices, such as headphones, peripheral speakers, and/or a peripheral display.

The input devices 416 can include any sort of input devices known in the art. For example, input devices 416 can include a microphone, a keyboard/keypad, and/or a touch-sensitive display, such as a touch-sensitive display screen. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 420 can store one or more sets of instructions, such as software or firmware, that embodies any one or more of the methodologies or functions described herein. The instructions can also reside, completely or at least partially, within the memory 404, processor(s) 408, and/or communication interface(s) 410 during execution thereof by the computing system 402. The memory 404 and the processor(s) 408 also can constitute machine readable media 420.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, comprising:
receiving, by one or more processors, user input indicating a first identifier of an individual associated with a policy;
identifying, by the one or more processors, a second identifier of a transfer source associated with the policy;
identifying, by the one or more processors, a third identifier of a transfer destination associated with the policy;
generating, by the one or more processors, computer-executable policy instructions associated with the policy, wherein the computer-executable policy instructions are configured to:
automatically execute, in a blockchain, and in response to a notice from a death record repository that indicates the first identifier of the individual, a transfer from the transfer source indicated by the second identifier to the transfer destination indicated by the third identifier; and
adding, by the one or more processors, a block associated with the computer-executable policy instructions to the blockchain.

2. The computer-implemented method of claim 1, wherein:
the death record repository is a Social Security Death Index (SSDI), and
the first identifier is a Social Security Number (SSN).

3. The computer-implemented method of claim 1, wherein the computer-executable policy instructions are associated with a death notice tracker that executes in the blockchain and is configured to automatically identify the notice based on the death record repository.

4. The computer-implemented method of claim 3, wherein:
a hashed version of the first identifier is stored in the computer-executable policy instructions in the block, and
the death notice tracker is configured to use the hashed version of the first identifier to determine that the notice is associated with the first identifier.

5. The computer-implemented method of claim 1, wherein:
the notice is received or generated by a death notice tracker, executing separately from the blockchain, based on the death record repository, and
the death notice tracker provides the notice to the blockchain to cause automatic execution of the computer-executable policy instructions.

6. The computer-implemented method of claim 1, wherein:
the computer-executable policy instructions comprise a smart contract associated with the policy,
the notice is received or generated by a death notice tracker, executing separately from the blockchain, based on the death record repository,
the death notice tracker maintains records, outside the blockchain, that map identifiers of individuals associated with policies to smart contract identifiers of smart contracts that correspond with the policies, and
the death notice tracker provides a smart contract identifier of the smart contract associated with the policy to the blockchain, to initiate automatic execution of the computer-executable policy instructions, in response to determining that the first identifier in the notice is in the records.

7. The computer-implemented method of claim 1, wherein:
instances of the policy are available to individuals who are at least a threshold age,
the first identifier provided in the user input is a Social Security Number (SSN) of the individual, and
the method further comprises verifying, by the one or more processors, and using a zero-knowledge proof, that the individual is at least the threshold age based on the SSN.

8. The computer-implemented method of claim 1, wherein:
the transfer source and the transfer destination are cryptocurrency wallets, and
the transfer is executed between the cryptocurrency wallets via the blockchain.

9. The computer-implemented method of claim 1, wherein access to the transfer destination is managed by a beneficiary manager element of a policy management system.

10. A computer-implemented method, comprising:
determining, by one or more processors, and based on a death record repository, a notice indicating an identifier of an individual;
determining, by the one or more processors, that the identifier indicated by the notice corresponds with execution conditions defined in computer-executable policy instructions, stored in a blockchain, associated with a policy; and
initiating, by the one or more processors, in response to the notice, automatic execution of the computer-executable policy instructions in the blockchain by automatically implementing a transfer from a transfer source identified in the computer-executable policy instructions to a transfer destination identified in the computer-executable policy instructions.

11. The computer-implemented method of claim 10, wherein:
the death record repository is a Social Security Death Index (SSDI), and
the identifier of the individual is a Social Security Number (SSN).

12. The computer-implemented method of claim 10, wherein the computer-executable policy instructions are associated with a death notice tracker that executes in the blockchain and is configured to determine the notice based on the death record repository.

13. The computer-implemented method of claim 10, wherein:
the notice is determined by a death notice tracker, executing separately from the blockchain, based on the death record repository, and
the death notice tracker provides the notice to the blockchain to initiate the automatic execution of the computer-executable policy instructions in the blockchain.

14. The computer-implemented method of claim 10, wherein:
the transfer source and the transfer destination are cryptocurrency wallets, and
the transfer is executed between the cryptocurrency wallets via the blockchain.

15. A computing system, comprising:
one or more processors, and
memory storing computer-executable instructions that, when executed by the one or more processors, cause the one or more processors to:
receive user input indicating a first identifier of an individual associated with a policy;
identify a second identifier of a transfer source associated with the policy;
identify a third identifier of a transfer destination associated with the policy;
generate computer-executable policy instructions associated with the policy, wherein the computer-executable policy instructions are configured to:
automatically execute, in a blockchain, and in response to a notice from a death record repository that indicates the first identifier of the individual, a transfer from the transfer source indicated by the second identifier to the transfer destination indicated by the third identifier; and
add a block associated with the computer-executable policy instructions to the blockchain.

16. The computing system of claim 15, wherein:
the death record repository is a Social Security Death Index (SSDI), and
the first identifier is a Social Security Number (SSN).

17. The computing system of claim 15, wherein the computer-executable policy instructions are associated with a death notice tracker that executes in the blockchain and is configured to automatically identify the notice based on the death record repository.

18. The computing system of claim 15, wherein the computer-executable instructions further cause the one or more processors to:
receive or generate the notice based on based on the death record repository, and
provide the notice to the blockchain to cause automatic execution of the computer-executable policy instructions.

19. The computing system of claim 15, wherein:
instances of the policy are available to individuals who are at least a threshold age,
the first identifier provided in the user input is a Social Security Number (SSN) of the individual, and
the computer-executable instructions further cause the one or more processors to verify, using a zero-knowledge proof, that the individual is at least the threshold age based on the SSN.

20. The computing system of claim 15, wherein:
the transfer source and the transfer destination are cryptocurrency wallets, and
the transfer is executed between the cryptocurrency wallets via the blockchain.
